(19) United States
(12) Patent Application Publication
(10) Pub. No.: US 2013/0337219 A1
(43) Pub. Date: Dec. 19, 2013

(54) Panel

(71) Applicant: Magna International Inc., Aurora (CA)

(72) Inventors: Scott D. Shields, White Lake, MI (US); Bradford David Armstrong, Barrie (CA)

(21) Appl. No.: 13/917,344

(22) Filed: Jun. 13, 2013

Related U.S. Application Data
(60) Provisional application No. 61/659,719, filed on Jun. 14, 2012.

(51) Int. Cl. B32B 5/26; B32B 7/12; B32B 3/12; B32B 5/02; B32B 5/12

(52) U.S. Cl. CPC B32B 5/26; B32B 5/022; B32B 5/12; B32B 3/12; B32B 5/024; B32B 7/12
USPC 428/76; 442/366; 428/113; 428/116; 442/281

(57) ABSTRACT

A panel is disclosed. The panel includes a core layer; one or more first reinforcement layers connected to the core layer and one or more second reinforcement layers connected to the one or more first reinforcement layers. The one or more first reinforcement layers includes randomly chopped fibers that impart stiffness to the panel in all directions (X, Y, Z). The one or more second reinforcement layers includes first directional fibers that impart stiffness to the panel in only one direction (X). Another panel is also disclosed. The panel includes a core layer; one or more first reinforcement layers connected to the core layer and one or more second reinforcement layers connected to the one or more first reinforcement layers. The one or more first reinforcement layers includes randomly chopped fibers that impart stiffness to the panel in all directions (X, Y, Z). The one or more second reinforcement layers includes a woven material including first directional fibers that are woven into second directional fibers. The first directional fibers impart stiffness to the panel in only a first direction (X). The second directional fibers impart stiffness to the panel in only a second direction that is substantially perpendicular to the first direction.

### CROSS-REFERENCE TO RELATED APPLICATIONS

This U.S. patent application claims priority to U.S. Provisional Application 61/659,719, filed on Jun. 14, 2012, the disclosures of which are considered part of the disclosure of this application and are hereby incorporated by reference in its entirety.

### TECHNICAL FIELD

The invention relates in general to a panel.

### BACKGROUND

It is known in the art that vehicles, such as, for example, automotive vehicles, include one or more panels (e.g., one or more interior trim components). Typically, an interior trim component provides a rigid and/or soft, aesthetically-pleasing surface that trims structure of a vehicle, such as, for example, roof structure, door structure, instrument panel structure, A-pillars, B-pillars, C-pillars, or the like Improvements to panels are constantly being sought in order to advance the art.

### BRIEF DESCRIPTION OF THE DRAWINGS

The disclosure will now be described, by way of example, with reference to the accompanying drawings, in which:

FIG. 1A is an exploded view of a panel in accordance with an exemplary embodiment of the invention.

FIG. 1B is a view of the panel of FIG. 1A connected to one or more additional layers of material panel in accordance with an exemplary embodiment of the invention.

FIG. 1C is a cross-sectional view according to line 1C-1C of FIG. 1B.

FIG. 2A is an exploded view of a panel in accordance with an exemplary embodiment of the invention.

FIG. 2B is a view of the panel of FIG. 2A connected to one or more additional layers of material panel in accordance with an exemplary embodiment of the invention.

FIG. 2C is a cross-sectional view according to line 2C-2C of FIG. 2B.

FIG. 3A is an exploded view of a panel in accordance with an exemplary embodiment of the invention.

FIG. 3B is a view of the panel of FIG. 3A connected to one or more additional layers of material panel in accordance with an exemplary embodiment of the invention.

FIG. 3C is a cross-sectional view according to line 3C-3C of FIG. 3B.

FIG. 4A is a cross-sectional view according to line 4-4 of FIG. 3A panel in accordance with an exemplary embodiment of the invention.

FIG. 4B is a cross-sectional view according to line 5-5 of FIG. 4A panel in accordance with an exemplary embodiment of the invention.

FIG. 4C is a cross-sectional view according to line 4-5 of FIG. 3A panel in accordance with an exemplary embodiment of the invention.

FIG. 5 is a view of a vehicle including the panel of one of FIGS. 1A-3C panel in accordance with an exemplary embodiment of the invention.

FIG. 6 is a view of a vehicle including the panel of one of FIGS. 1A-3C panel in accordance with an exemplary embodiment of the invention.

FIG. 7 is a view of a non-vehicular structural member including the panel of one of FIGS. 1A-3C panel in accordance with an exemplary embodiment of the invention.

### DETAILED DESCRIPTION

The Figures illustrate exemplary embodiments of a panel in accordance with an embodiment of the invention. Based on the foregoing, it is to be generally understood that the nomenclature used herein is simply for convenience and the terms used to describe the invention should be given the broadest meaning by one of ordinary skill in the art.

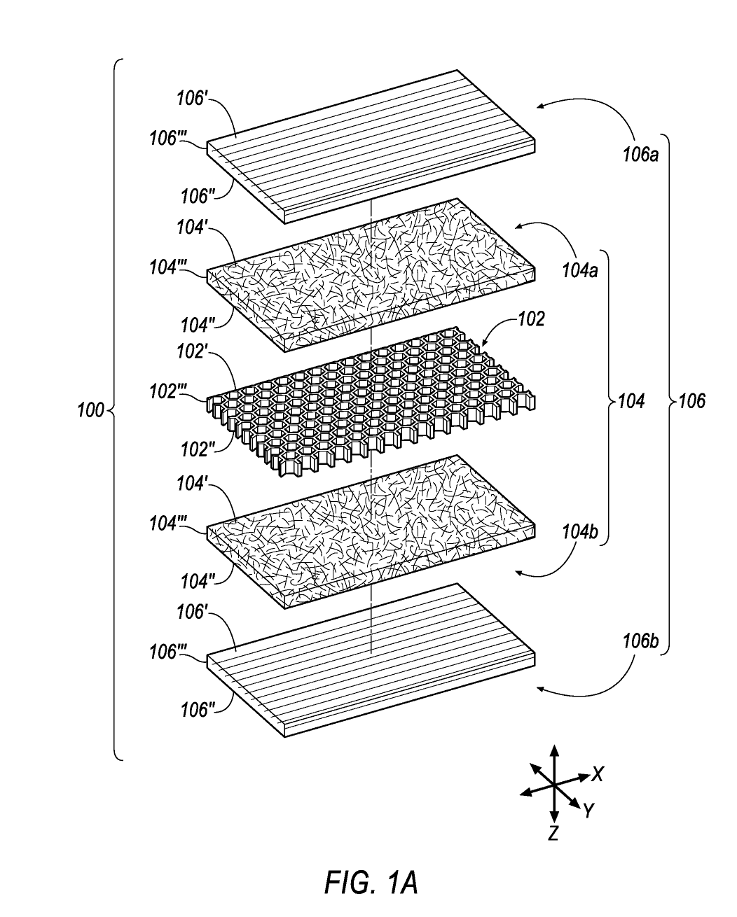

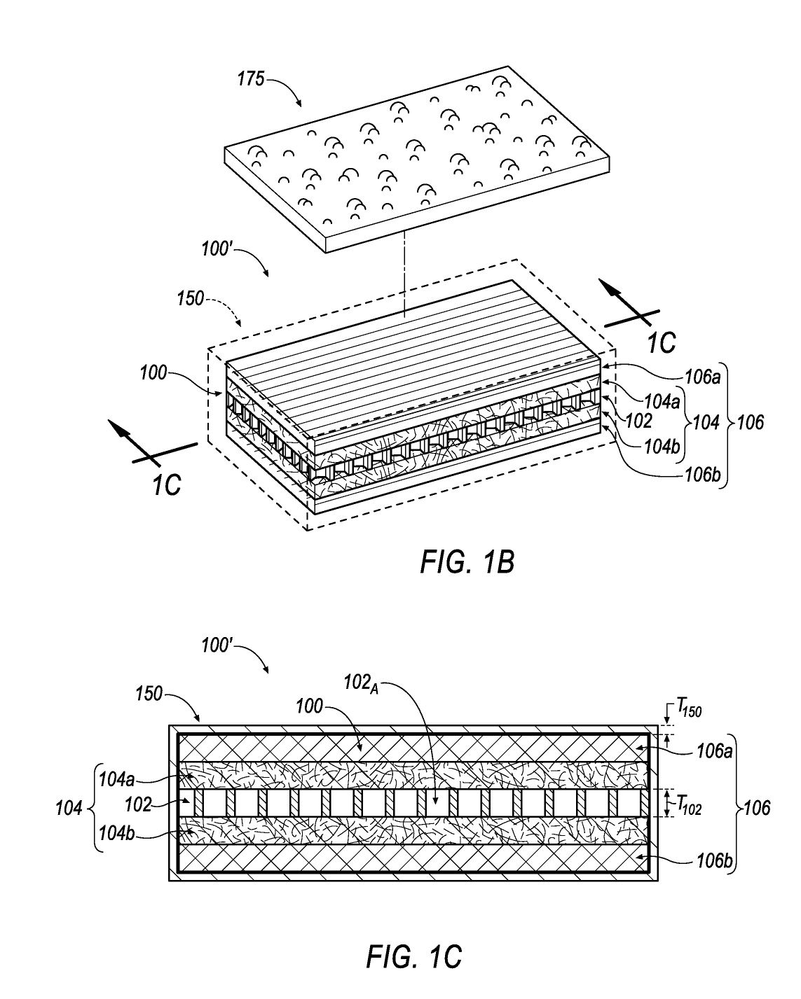

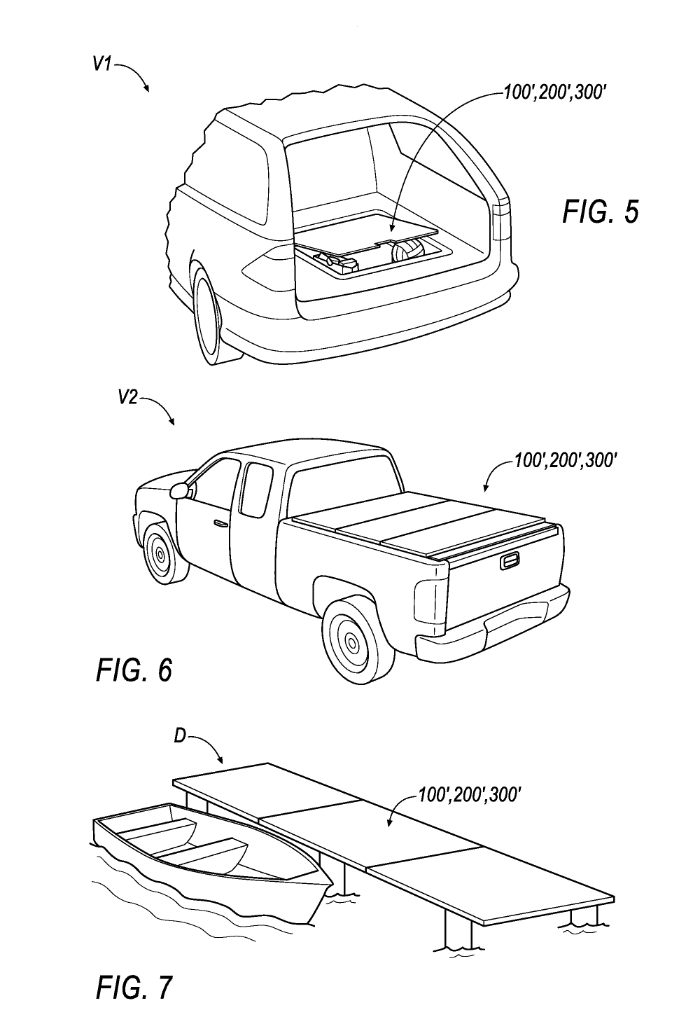

Referring to FIG. 1A, an embodiment of a panel including a plurality of layers 102, 104, 106 is shown generally at 100 according to an embodiment. As seen in FIG. 1B, an embodiment of a panel 100′ may include a plurality of layers 102, 104, 106 that are arranged adjacent one another (as seen in, e.g., the panel 100 of FIG. 1A) that are subsequently exposed to an encasing material 150 that may impregnate one or more of the plurality of layers 102, 104, 106 of the panel 100 for adhering the plurality of layers 102, 104, 106 of the panel 100. One or more decorative layers, such as, for example, an “A-surface” layer 175 or a trim layer may be connected to (e.g., adhered to) an outer surface of the encasing material 150; an “A-surface” layer 175 may be exposed to, for example, a passenger compartment area of a vehicle, V1 (see, e.g., FIG. 6), and be seen by, for example, passengers within the passenger compartment area of the vehicle, V1.

Referring to FIG. 1A, the panel 100 may include: a core layer 102, one or more first reinforcement layers 104 and one or more second reinforcement layers 106. The one or more first reinforcement layers 104 may include an upper layer 104a and a lower layer 104b. The one or more second reinforcement layers 106 may include an upper layer 106a and a lower layer 106b.

The core layer 102 may include an upper surface 102′, a lower surface 102″ and one or more side surfaces 102′″. The upper surface 102′ is opposite the lower surface 102″. The one or more side surfaces 102′″ connects the upper surface 102′ to the lower surface 102″. The core layer 102 may include any desirable material, such as, for example, polypropylene (PP), a paper material or a urethane foam material. In some implementations, the core layer 102 may be shaped to include a “honeycomb” geometry forming a plurality of voids/passages/air gaps 102_{A} (see, e.g., FIG. 1C).

Each of the upper layer 104a, 106a and the lower layer 104b, 106b of the one or more first and second reinforcement layers 104, 106 may include an upper surface 104′, 106′ a lower surface 104″, 106″, and one or more side surfaces 104′″, 106′″. The upper surface 104′, 106′ is opposite the lower surface 104″, 106″. The one or more side surfaces 104′″, 106′″ connects the upper surface 104′, 106′ to the lower surface 104″, 106″.

In an embodiment, the one or more first reinforcement layers 104 may include any desirable material, such as, for example, randomly chopped fibers that are bound together with any desirable material (e.g., polyurethane (PU), polypropylene (PP) or the like). In an implementation, the randomly chopped fibers of the one or more first reinforcement layers 104 may include, for example, randomly chopped glass fibers. In another implementation, the randomly chopped fibers of the one or more first reinforcement layers 104 may include, for example, randomly chopped carbon fibers. In yet another implementation, the randomly chopped fibers of the one or more first reinforcement layers 104 may include, for example, randomly chopped aramid fibers. In other implementations, the randomly chopped fibers of the one or more first reinforcement layers 104 may include a mixture of one or more of: randomly chopped glass fibers, randomly chopped carbon fibers and randomly chopped aramid fibers.

In an embodiment, the one or more second reinforcement layers 106 include any desirable material, such as, for example, unidirectional fibers that are bound together with any desirable material (e.g., polyurethane (PU), polypropylene (PP) or the like). In an implementation, the unidirectional fibers of the one or more second reinforcement layers 106 may include, for example, unidirectional glass fibers. In another implementation, the unidirectional fibers of the one or more second reinforcement layers 106 may include, for example, unidirectional carbon fibers. In yet another implementation, the unidirectional fibers of the one or more second reinforcement layers 106 may include, for example, unidirectional aramid fibers. In other implementations, the unidirectional fibers of the one or more second reinforcement layers 106 may include a mixture of one or more of: unidirectional glass fibers, unidirectional carbon fibers and unidirectional aramid fibers.

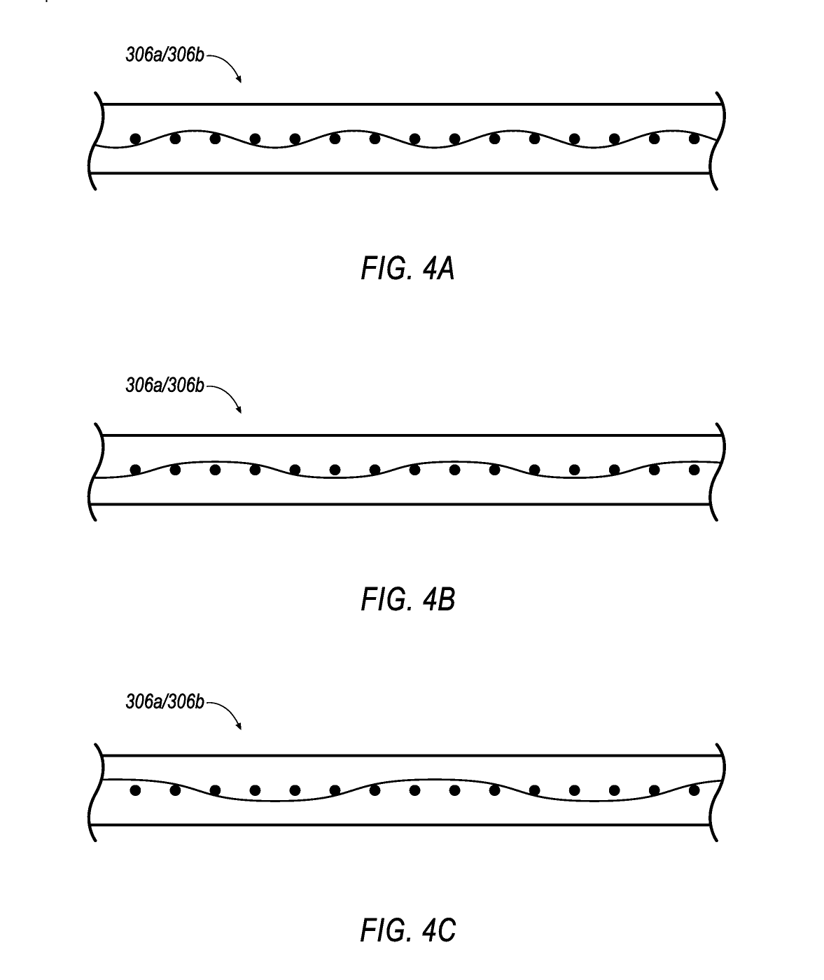

As described above, in an implementation, the one or more first reinforcement layers 104 may include, for example, randomly chopped fibers whereas the one or more second reinforcement layers 106 may include, for example, unidirectional fibers. Because of the random orientation of randomly chopped fibers, adjacent fibers in a randomly chopped fiber layer are typically not aligned in, for example, a parallel or sinusoidal arrangement. Conversely, adjacent fibers in a unidirectional layer are in a parallel or sinusoidal, non-overlapping arrangement. Functionally, randomly chopped fibers provide nearly equal stiffness performance in all directions (see, e.g., arrows X, Y, Z) whereas unidirectional fibers, however, focuses stiffness in one direction (see, e.g., arrow, X, or arrow, Y); unidirectional fibers may be useful when arranged in a structure that is geometrically long and narrow. In some implementations, one or more of the randomly chopped and unidirectional fiber layers may be replaced with a woven fiber layer (see, e.g., 406a, 406b of FIGS. 4A-4C) in order to focus stiffness in two directions (see, e.g., arrows, X and Y, that are substantially perpendicular to one another) rather than one direction, X or Y, (as found in a unidirectional arrangement of fibers), or all directions, X, Y, Z (as found in a random arrangement of fibers). The panel 100 does not include metal or metal reinforcements in order to provide stiffness in any direction, X, Y, Z; stiffness in any direction is provided by the orientation of the fibers of the first and second reinforcement layers 104, 106.

The panel 100 may be formed by firstly arranging: (1) the lower surface 104″ of the upper first reinforcement layer 104a adjacent the upper surface 102′ of the core layer 102, and (2) the upper surface 104′ of the lower first reinforcement layer 104b adjacent the lower surface 102″ of the core layer 102. Then, the panel 100 is further formed by secondly arranging: (1) the lower surface 106″ of the upper second reinforcement layer 106a adjacent the upper surface 104′ of the upper first reinforcement layer 104a, and (2) the upper surface 106′ of the lower second reinforcement layer 106b adjacent the lower surface 104″ of the lower first reinforcement layer 104b.

Referring to FIG. 1B, once the layers 102, 104, 106 are arranged as described above in order to form the panel 100, an encasing material 150 is deposited upon the panel 100. In some implementations, the encasing material 150 may include any desirable material, such as, for example, polyurethane (PU). In other implementations, the encasing material 150 may include, for example, polypropylene (PP). The encasing material 150 may be deposited upon the panel 100 in desirable methodology such as, for example, a spraying methodology.

The encasing material 150 may impregnate one or more the first and second reinforcement layers 104, 106 of the panel 100 for adhering one or more of the core layer 102, the first reinforcement layers 104 and the second reinforcement layers 106 together for forming a panel 100′. In some implementations, the encasing material 150 may seep through both of the upper layers 104a, 106a and the lower layers 104b, 106b of the first and second reinforcement layers 104, 106 such that the encasing material 150 may subsequently directly contact the upper and lower surfaces 102a, 102b of the core layer 102. The encasing material 150 may, however, not impregnate a thickness, T₁₀₂ (see, e.g., FIG. 1C) of the core layer 102 and not enter into any of the plurality of voids/passages/air gaps 102_{A} of the core layer 102.

In some implementations, the encasing material 150 may include a relatively thin coating defining a thickness, T₁₅₀, about the exterior surfaces of the panel 100. The exterior surfaces of the panel 100 may include, for example: (1) the upper surface 106′ of the upper second reinforcement layer 106a, (2) the lower surface 106″ of the lower second reinforcement layer 106b and (3) the one or more side surfaces 102′″, 104′″, 106′″ of the core layer 102, the one or more first reinforcement layers 104 and the one or more second reinforcement layers 106.

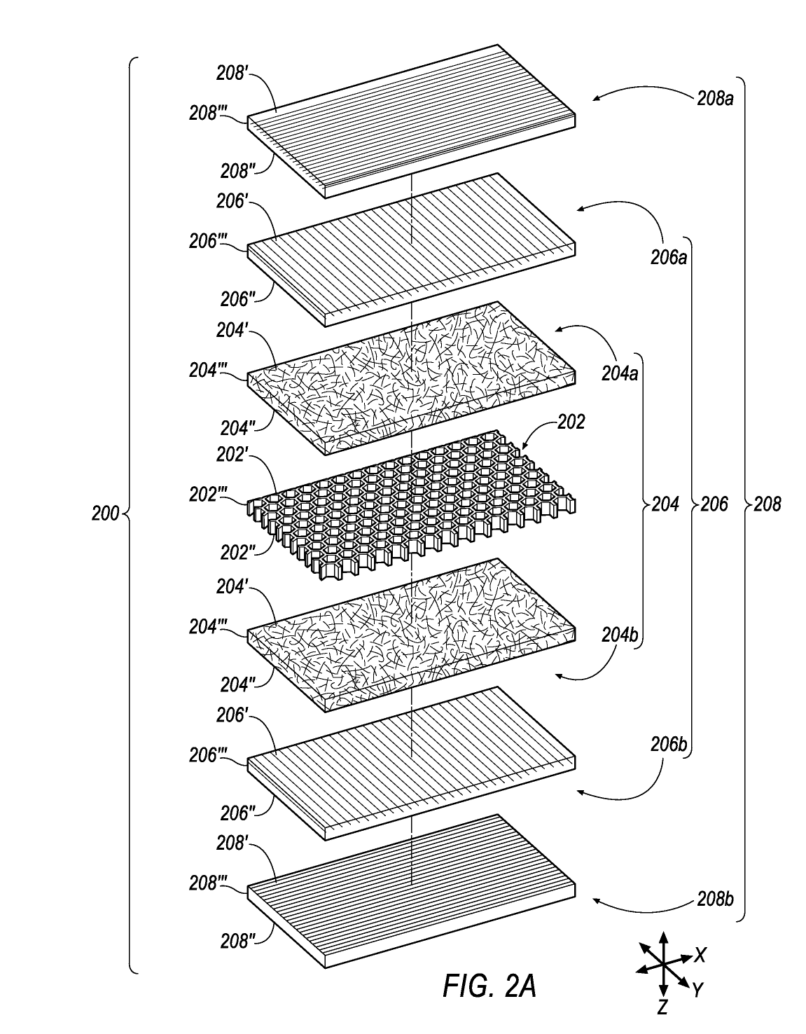

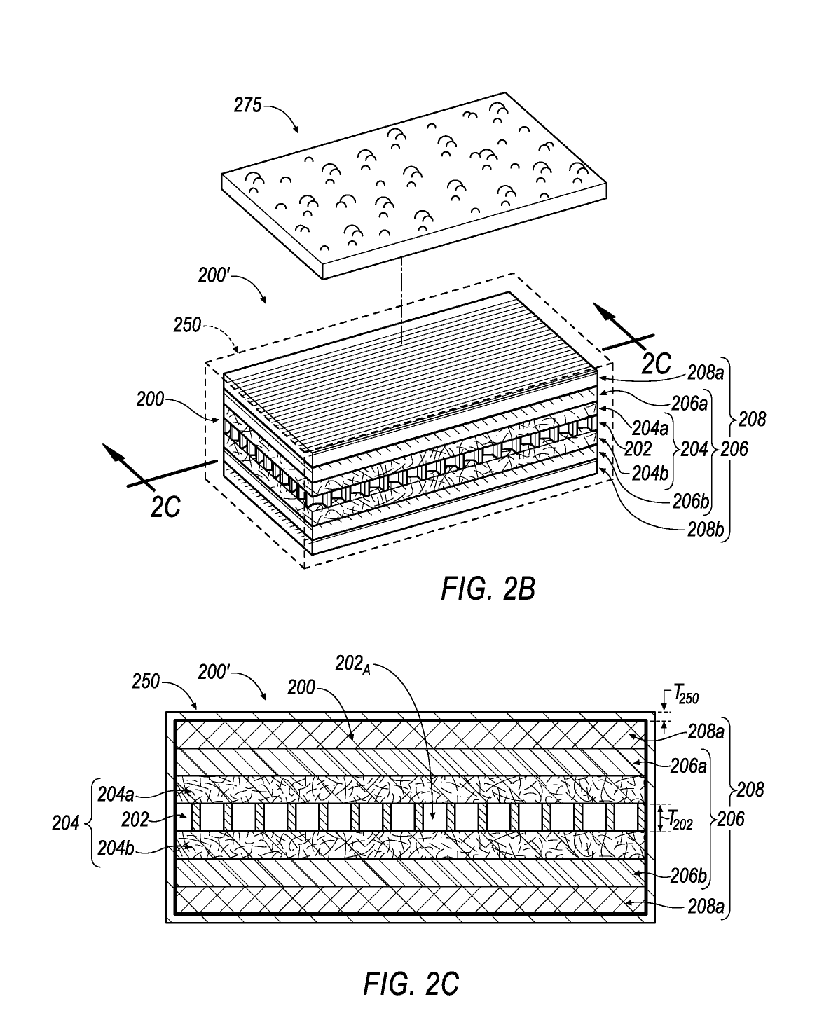

Referring to FIG. 2A, an embodiment of a panel including a plurality of layers 202, 204, 206, 208 is shown generally at 200 according to an embodiment. As seen in FIG. 2B, an embodiment of a panel 200′ may include a plurality of layers 202, 204, 206, 208 that are arranged adjacent one another (as seen in, e.g., the panel 200 of FIG. 2A) that are subsequently exposed to an encasing material 250 that may impregnate the plurality of layers 202, 204, 206, 208 of the panel 200 for adhering together the plurality of layers 202, 204, 206, 208 of the panel 200. One or more decorative layers, such as, for example, an “A-surface” layer 275 or a trim layer may be connected to (e.g., adhered to) an outer surface of the encasing material 250; an “A-surface” layer 275 may be exposed to, for example, a passenger compartment area of a vehicle, V1, and be seen by, for example, passengers within the passenger compartment area of the vehicle, V1.

The panel 200 may include: a core layer 202, one or more first reinforcement layers 204, one or more second reinforcement layers 206 and one or more third reinforcement layers 208. The one or more first reinforcement layers 204 may include an upper layer 204a and a lower layer 204b. The one or more second reinforcement layers 206 may include an upper layer 206a and a lower layer 206b. The one or more third reinforcement layers 208 may include an upper layer 208a and a lower layer 208b.

The core layer 202 may include an upper surface 202′, a lower surface 202″ and one or more side surfaces 202″. The upper surface 202′ is opposite the lower surface 202″. The one or more side surfaces 202′″ connects the upper surface 202′ to the lower surface 202″. The core layer 202 may include any desirable material, such as, for example, polypropylene (PP), a paper material or a urethane foam material. In some implementations, the core layer 202 may be shaped to include a “honeycomb” geometry forming a plurality of voids/passages/air gaps 202_{A}.

Each of the upper layer 204a, 206a, 208a and the lower layer 204b, 206b, 208b of the one or more first, second and third reinforcement layers 204, 206, 208 may include an upper surface 204′, 206′, 208′ a lower surface 204″, 206″, 208″and one or more side surfaces 204′″, 206′″, 208′″. The upper surface 204′, 206′, 208′ is opposite the lower surface 204″, 206″, 208″. The one or more side surfaces 204′″, 206′″, 208′″ connects the upper surface 204′, 206′, 208′ to the lower surface 204″, 206″, 208″.

In an embodiment, the one or more first reinforcement layers 204 may include any desirable material, such as, for example, randomly chopped fibers that are bound together with any desirable material (e.g., polyurethane (PU), polypropylene (PP) or the like). In an implementation, the randomly chopped fibers of the one or more first reinforcement layers 204 may include, for example, randomly chopped glass fibers. In another implementation, the randomly chopped fibers of the one or more first reinforcement layers 204 may include, for example, randomly chopped carbon fibers. In yet another implementation, the randomly chopped fibers of the one or more first reinforcement layers 204 may include, for example, randomly chopped aramid fibers. In other implementations, the randomly chopped fibers of the one or more first reinforcement layers 204 may include a mixture of one or more of: randomly chopped glass fibers, randomly chopped carbon fibers and randomly chopped aramid fibers.

In an embodiment, the one or more second and third reinforcement layers 206, 208 include any desirable material, such as, for example, unidirectional fibers that are bound together with any desirable material (e.g., polyurethane (PU), polypropylene (PP) or the like). In an implementation, the unidirectional fibers of the one or more second and third reinforcement layers 206, 208 may include, for example, unidirectional glass fibers. In another implementation, the unidirectional fibers of the one or more second and third reinforcement layers 206, 208 may include, for example, unidirectional carbon fibers. In yet another implementation, the unidirectional fibers of the one or more second and third reinforcement layers 206, 208 may include, for example, unidirectional aramid fibers. In other implementations, the unidirectional fibers of the one or more second and third reinforcement layers 206, 208 may include a mixture of one or more of: unidirectional glass fibers, unidirectional carbon fibers and unidirectional aramid fibers.

As described above, in an implementation, the one or more first reinforcement layers 204 may include, for example, randomly chopped fibers whereas the one or more second and third reinforcement layers 206, 208 may include, for example, unidirectional fibers. Because of the random orientation of randomly chopped fibers, adjacent fibers in a randomly chopped fiber layer are typically not aligned in, for example, a parallel or sinusoidal arrangement. Conversely, adjacent fibers in a unidirectional layer are in a parallel or sinusoidal, non-overlapping arrangement. Functionally, randomly chopped fibers provide nearly equal stiffness performance in all directions (see, e.g., arrows X, Y, Z) whereas unidirectional fibers, however, focuses stiffness in one direction (see, e.g., arrow, X, or arrow, Y); unidirectional fibers may be useful when arranged in a structure that is geometrically long and narrow. In some implementations, one or more of the randomly chopped and unidirectional fiber layers may be replaced with a woven fiber layer (see, e.g., 406a, 406b of FIGS. 4A-4C) in order to focus stiffness in two directions (see, e.g., arrows, X and Y, that are substantially perpendicular to one another) rather than one direction, X or Y (as found in a unidirectional arrangement of fibers), or all directions, X, Y, Z, (as found in a random arrangement of fibers). The panel 200 does not include metal or metal reinforcements in order to provide stiffness in any direction, X, Y, Z; stiffness in any direction is provided by the orientation of the fibers of the first, second and third reinforcement layers 204, 206, 208.

Although the second and third reinforcement layers 206, 208 are not one layer comprising a woven layer, the parallel orientation of the unidirectional fibers of the second reinforcement layer 206 are substantially perpendicular (i.e., the second reinforcement layer 206 is arranged angle of 0°) with respect to the parallel orientation of the unidirectional fibers of the third reinforcement layer 208 (i.e., the third reinforcement layer 208 is arranged at an angle of 90°). Further, in some embodiments, the one or more third reinforcement layers 208 may include more unidirectional fibers than that of the one or more second reinforcement layers 206; in some implementations, the one or more third reinforcement layers 208 may be greater than or equal to one-and-a-half (1.5) times the amount of unidirectional fibers of the one or more second reinforcement layers 206.

The panel 200 may be formed by firstly arranging: (1) the lower surface 204″ of the upper first reinforcement layer 204a adjacent the upper surface 202′ of the core layer 202, and, (2) the upper surface 204′ of the lower first reinforcement layer 204b adjacent the lower surface 202″ of the core layer 202. Then, the panel 200 is further formed by secondly arranging: (1) the lower surface 206″ of the upper second reinforcement layer 206a adjacent the upper surface 204′ of the upper first reinforcement layer 204a, and (2) the upper surface 206′ of the lower second reinforcement layer 206b adjacent the lower surface 204″ of the lower first reinforcement layer 204b. Then, the panel 200 is further formed by thirdly arranging: (1) the lower surface 208″ of the upper third reinforcement layer 208a adjacent the upper surface 206′ of the upper second reinforcement layer 206a, and (2) the upper surface 208′ of the lower third reinforcement layer 208b adjacent the lower surface 206″ of the lower second reinforcement layer 206b.

Referring to FIG. 2B, once the layers 202, 204, 206, 208 are arranged as described above in order to form the panel 200, an encasing material 250 is deposited upon the panel 200. In some implementations, the encasing material 250 may include any desirable material, such as, for example, polyurethane (PU). In other implementations, the encasing material 250 may include, for example, polypropylene (PP). The encasing material 250 may be deposited upon the panel 200 in desirable methodology such as, for example, a spraying methodology.

The encasing material 250 may impregnate one or more the first, second and third reinforcement layers 204, 206, 208 of the panel 200 for adhering one or more of the core layer 202, the first reinforcement layers 204, the second reinforcement layers 206 and the third reinforcement layers 208 together for forming a panel 200′. In some implementations, the encasing material 250 may seep through both of the upper layers 204a, 206a, 208a and the lower layers 204b, 206b, 208b of the first, second and third reinforcement layers 204, 206, 208 such that the encasing material 250 may subsequently directly contact the upper and lower surfaces 202a, 202b of the core layer 202. The encasing material 250 may, however, not impregnate a thickness, T₂₀₂, of the core layer 202 and not enter into any of the plurality of voids/passages/air gaps 202_{A} of the core layer 202.

In some implementations, the encasing material 250 may include a relatively thin coating defining a thickness, T₂₅₀, about the exterior surfaces of the panel 200. The exterior surfaces of the panel 200 may include, for example: (1) the upper surface 208′ of the upper third reinforcement layer 208a, (2) the lower surface 208″ of the lower third reinforcement layer 208b and (3) the one or more side surfaces 202′″, 204′″, 206′″, 208′″ of the core layer 202, the one or more first reinforcement layers 204, the one or more second reinforcement layers 206 and the one or more third reinforcement layers 208.

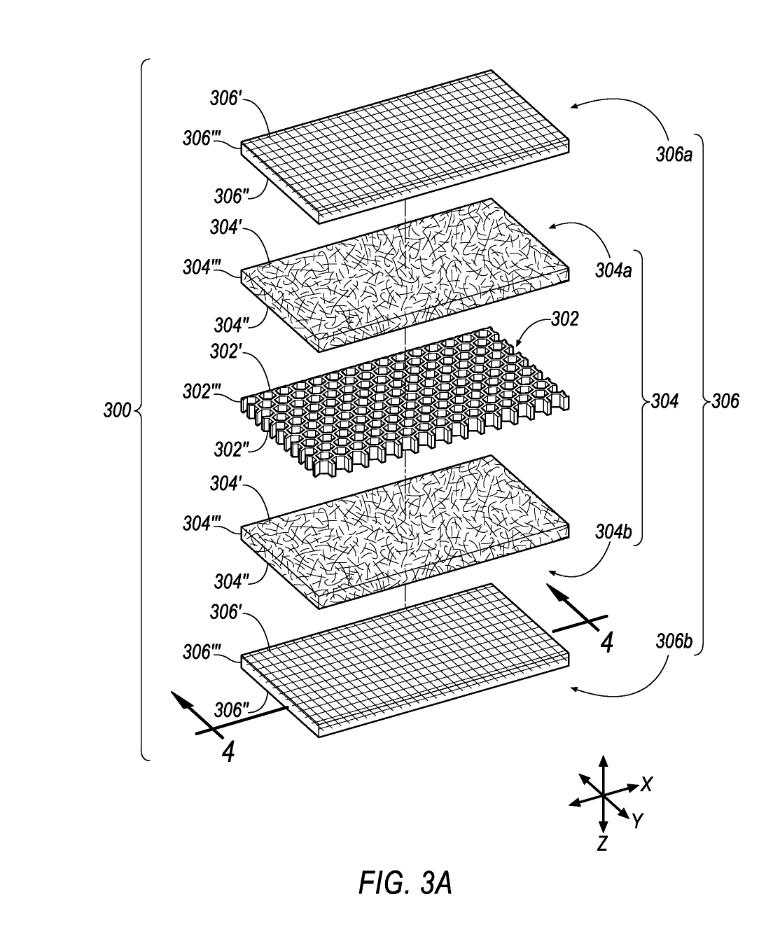

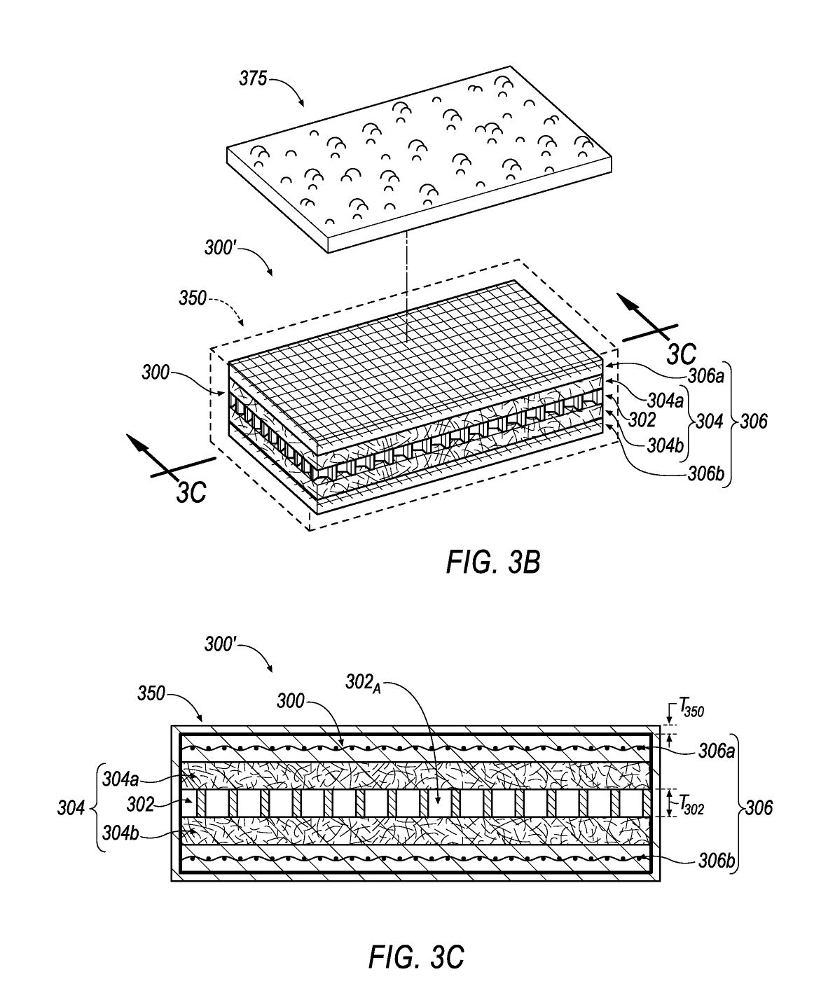

Referring to FIG. 3A, an embodiment of a panel including a plurality of layers 302, 304, 306 is shown generally at 300 according to an embodiment. As seen in FIG. 3B, an embodiment of a panel 300′ may include a plurality of layers 302, 304, 306 that are arranged adjacent one another (as seen in, e.g., the panel 400 of FIG. 3A) that are subsequently exposed to an encasing material 350350 that may impregnate one or more layers 302, 304, 306 of the panel 300 for adhering together the plurality of layers 302, 304, 306 of the panel 300. One or more decorative layers, such as, for example, an “A-surface” layer 375 or a trim layer may be connected to (e.g., adhered to) an outer surface of the encasing material 350350; an “A-surface” layer 375 may be exposed to, for example, a passenger compartment area of a vehicle, V1, and be seen by, for example, passengers within the passenger compartment area of the vehicle, V1.

The panel 300 may include: a core layer 302, one or more first reinforcement layers 304 and one or more second reinforcement layers 306. The one or more first reinforcement layers 304 may include an upper layer 304a and a lower layer 304b. The one or more second reinforcement layers 306 may include an upper layer 406a and a lower layer 306b.

The core layer 302 may include an upper surface 302′, a lower surface 302″ and one or more side surfaces 302″. The upper surface 302′ is opposite the lower surface 302″. The one or more side surfaces 302′″ connects the upper surface 302′ to the lower surface 302″. The core layer 302 may include any desirable material, such as, for example, polypropylene (PP), a paper material or a urethane foam material. In some implementations, the core layer 302 may be shaped to include a “honeycomb” geometry forming a plurality of voids/passages/air gaps 302_{A}.

Each of the upper layer 304a, 306a and the lower layer 304b, 306b of the one or more first and second reinforcement layers 304, 306 may include an upper surface 304′, 306′ a lower surface 304″, 306″, and one or more side surfaces 304′″, 306′″. The upper surface 304′, 306′ is opposite the lower surface 304″, 306″. The one or more side surfaces 304′″, 306′″ connects the upper surface 304′, 306′ to the lower surface 304″, 306″.

In an embodiment, the one or more first reinforcement layers 304 may include any desirable material, such as, for example, randomly chopped fibers that are bound together with any desirable material (e.g., polyurethane (PU), polypropylene (PP) or the like). In an implementation, the randomly chopped fibers of the one or more first reinforcement layers 304 may include, for example, randomly chopped glass fibers. In another implementation, the randomly chopped fibers of the one or more first reinforcement layers 304 may include, for example, randomly chopped carbon fibers. In yet another implementation, the randomly chopped fibers of the one or more first reinforcement layers 304 may include, for example, randomly chopped aramid fibers. In other implementations, the randomly chopped fibers of the one or more first reinforcement layers 304 may include a mixture of one or more of: randomly chopped glass fibers, randomly chopped carbon fibers and randomly chopped aramid fibers.

In an embodiment, the one or more second reinforcement layers 306 include any desirable material, such as, for example, bi-directional fibers that are bound together with any desirable material (e.g., polyurethane (PU), polypropylene (PP) or the like). In an implementation, the bi-directional fibers of the one or more second reinforcement layers 306 may include, for example, bi-directional glass fibers. In another implementation, the bi-directional fibers of the one or more second reinforcement layers 306 may include, for example, bi-directional carbon fibers. In yet another implementation, the bi-directional fibers of the one or more second reinforcement layers 306 may include, for example, bi-directional aramid fibers. In other implementations, the bi-directional fibers of the one or more second reinforcement layers 306 may include a mixture of one or more of: bi-directional glass fibers, bi-directional carbon fibers and bi-directional aramid fibers.

As described above, in an implementation, the one or more first reinforcement layers 304 may include, for example, randomly chopped fibers whereas the one or more second reinforcement layers 306 may include, for example, bi-directional fibers. Because of the random orientation of randomly chopped fibers, adjacent fibers in a randomly chopped fiber layer are typically not aligned in, for example, a parallel arrangement, a sinusoidal arrangement or an ordered arrangement (e.g., an overlapped, grid-shaped arrangement of columns and rows of fibers). Conversely, adjacent fibers in a bi-directional layer may be arranged in an ordered arrangement (e.g., an overlapped, grid-shaped arrangement of columns and rows of fibers). Functionally, randomly chopped fibers provide nearly equal stiffness performance in all directions (see, e.g., arrows X, Y, Z) whereas an ordered arrangement (e.g., an overlapped, grid-shaped arrangement of columns and rows of fibers) of fibers may be arranged in, for example, a woven orientation (see, e.g., FIGS. 4A-4C) in order to focus stiffness in two directions (see, e.g., arrows, X and Y, that are substantially perpendicular to one another) rather than one direction, X or Y (as found in a unidirectional arrangement of fibers), or all directions, X, Y, Z, (as found in a random arrangement of fibers). The panel 300 does not include metal or metal reinforcements in order to provide stiffness in any direction, X, Y, Z; stiffness in any direction is provided by the orientation of the fibers of the first and second reinforcement layers 304, 306.

Referring to FIGS. 4A-4C, the upper and lower second reinforcement layers 306a, 306b arranged in a woven orientation are shown according to an embodiment. The woven orientation of the upper and lower second reinforcement layers 306a, 306b may include any desirable weave pattern having any desirable ratio of bias in the two directions (see, e.g., arrows, X and Y, that are substantially perpendicular to one another) forming the bi-directional arrangement of fibers. In an implementation, as seen in FIG. 4A, the upper and lower second reinforcement layers 306a, 306b may be woven in a manner to oscillate in a sinusoidal pattern resulting in a fiber “jumping” two adjacent perpendicularly-arranged fibers and then subsequently “ducking” two adjacent perpendicularly-arranged fibers. In an implementation, as seen in FIG. 4B, the upper and lower second reinforcement layers 306a, 306b may be woven in a manner to oscillate in a sinusoidal pattern resulting in a fiber “jumping” three adjacent perpendicularly-arranged fibers and then subsequently “ducking” three adjacent perpendicularly-arranged fibers. In an implementation, as seen in FIG. 4C, the upper and lower second reinforcement layers 306a, 306b may be woven in a manner to oscillate in a sinusoidal pattern resulting in a fiber “jumping” four adjacent perpendicularly-arranged fibers and then subsequently “ducking” four adjacent perpendicularly-arranged fibers.

Referring to FIGS. 3A-3C, the panel 300 may be formed by firstly arranging: (1) the lower surface 304″ of the upper first reinforcement layer 304a adjacent the upper surface 302′ of the core layer 302, and, (2) the upper surface 304′ of the lower first reinforcement layer 304b adjacent the lower surface 302″ of the core layer 302. Then, the panel 300 is further formed by secondly arranging: (1) the lower surface 306″ of the upper second reinforcement layer 306a adjacent the upper surface 304′ of the upper first reinforcement layer 304a, and (2) the upper surface 306′ of the lower second reinforcement layer 306b adjacent the lower surface 304″ of the lower first reinforcement layer 304b.

Referring to FIG. 3B, once the layers 302, 304, 306 are arranged as described above in order to form the panel 300, an encasing material 350 is deposited upon the panel 300. In some implementations, the encasing material 350350 may include any desirable material, such as, for example, polyurethane (PU). In other implementations, the encasing material 350 may include, for example, polypropylene (PP). The encasing material 350 may be deposited upon the panel 300 in desirable methodology such as, for example, a spraying methodology.

The encasing material 350350 may impregnate one or more the first and second reinforcement layers 304, 306 of the panel 300 for adhering one or more of the core layer 302, the first reinforcement layers 304 and the second reinforcement layers 306 together for forming a panel 300′. In some implementations, the encasing material 350 may seep through both of the upper layers 304a, 306a and the lower layers 304b, 306b of the first and second reinforcement layers 304, 306 such that the encasing material 350 may subsequently directly contact the upper and lower surfaces 302a, 302b of the core layer 302. The encasing material 350 may, however, not impregnate a thickness, T₃₀₂, of the core layer 302 and not enter into any of the plurality of voids/passages/air gaps 302_{A} of the core layer 302.

In some implementations, the encasing material 350 may include a relatively thin coating defining a thickness, T₃₅₀, about the exterior surfaces of the panel 300. The exterior surfaces of the panel 300 may include, for example: (1) the upper surface 306′ of the upper second reinforcement layer 306a, (2) the lower surface 306″ of the lower second reinforcement layer 306b and (3) the one or more side surfaces 302′″, 304′″, 306′″ of the core layer 302, the one or more first reinforcement layers 304 and the one or more second reinforcement layers 306.

Referring to FIGS. 5-7, the panel 100′, 200′, 300′, 300′ may be utilized in any desirable implementation. In an implementation, referring to FIG. 6, the panel 100′, 200′, 300′ may be utilized as a vehicular interior trim component that is arranged within a passenger compartment of a vehicle, V1; in some implementations, the panel 100′, 200′, 300′ may be a load floor door of a cargo compartment of a vehicle, V1. In an implementation, referring to FIG. 6, the panel 100′, 200′, 300′ may be utilized as a vehicular exterior trim component that is arranged outside of a passenger compartment of a vehicle, V2; in some implementations, the panel 100′, 200′, 300′ may be a pick-up truck bed cover. In an implementation, referring to FIG. 7, the panel 100′, 200′, 300′ may be utilized as a non-vehicular component that forms a structural member; in some implementations, the panel 100′, 200′, 300′ may be deck panel, dock panel or the like.

The present invention has been described with reference to certain exemplary embodiments thereof. However, it will be readily apparent to those skilled in the art that it is possible to embody the invention in specific forms other than those of the exemplary embodiments described above. This may be done without departing from the spirit of the invention. The exemplary embodiments are merely illustrative and should not be considered restrictive in any way. The scope of the invention is defined by the appended claims and their equivalents, rather than by the preceding description.

What is claimed is:

1. A panel comprising:
a core layer;
one or more first reinforcement layers connected to the core layer wherein the one or more first reinforcement layers includes randomly chopped fibers that impart stiffness to the panel in all directions (X, Y, Z); and
one or more second reinforcement layers connected to the one or more first reinforcement layers, wherein the one or more second reinforcement layers includes first directional fibers that impart stiffness to the panel in only one direction (X).

2. The panel according to claim 1 further comprising:
an encasing material that impregnates the one or more first reinforcement layers and the one or more second reinforcement layers for adhering:
the core layer to the one or more first reinforcement layers, and
the one or more first reinforcement layers to the one or more second
reinforcement layers for forming
an encased panel.

3. The panel according to claim 2, wherein the encasing material includes
a polyurethane material.

4. The panel according to claim 2, wherein the encasing material includes
a polypropylene material.

5. The panel according to claim 1, wherein the randomly chopped fibers of the one or more first reinforcement layers and the first directional fibers of the one or more second reinforcement layers are each bound together with
a polyurethane material.

6. The panel according to claim 1, wherein the randomly chopped fibers of the one or more first reinforcement layers and the first directional fibers of the one or more second reinforcement layers are each bound together with
a polypropylene material.

7. The panel according to claim 1, wherein the first directional fibers of the one or more second reinforcement layers are
linear fibers.

8. The panel according to claim 1 further comprising:
one or more third reinforcement layers connected to the one or more second reinforcement layers, wherein the one or more second reinforcement layers includes
second directional fibers that are substantially perpendicularly arranged with respect to the first directional fibers of the one or more first reinforcement layers for imparting stiffness to the panel in only one direction (Y) that is substantially perpendicular to the only one direction (X) of the first directional fibers.

9. The panel according to claim 8, wherein second directional fibers of the one or more third reinforcement layers are each bound together with
a polyurethane material.

10. The panel according to claim 8, wherein second directional fibers of the one or more third reinforcement layers are each bound together with
a polypropylene material.

11. The panel according to claim 8, wherein an amount of first directional fibers of the one or more second reinforcement layers is not equal to an amount of second directional fibers of the one or more third reinforcement layers; wherein the amount of second directional fibers of the one or more third reinforcement layers is greater than or equal to approximately about one-and-a-half times the amount of first directional fibers of the one or more second reinforcement layers.

12. The panel according to claim 8, wherein both of the first directional fibers of the one or more second reinforcement layers and the second directional fibers of the one or more third reinforcement layers are
linear fibers.

13. The panel according to claim 8, wherein both of the first directional fibers of the one or more second reinforcement layers and the second directional fibers of the one or more third reinforcement layers are
sinusoidal fibers.

14. The panel according to claim 1, wherein the core layer includes
a honeycomb geometry.

15. The panel according to claim 14, wherein the core layer includes a material that is selected from the group consisting of: polypropylene, paper and polyurethane foam.

16. The panel according to claim 1, wherein the panel does not include metal or metal reinforcements in order to provide stiffness in any direction (X, Y, Z).

17. A panel, comprising:
a core layer;
one or more first reinforcement layers connected to the core layer wherein the one or more first reinforcement layers includes
randomly chopped fibers that impart stiffness to the panel in all directions (X, Y, Z); and
one or more second reinforcement layers connected to the one or more first reinforcement layers, wherein the one or more second reinforcement layers includes
a woven material including
first directional fibers that are woven into second directional fibers, wherein the first directional fibers impart stiffness to the panel in only a first direction (X), wherein the second directional fibers impart stiffness to the panel in only a second direction that is substantially perpendicular to the first direction.

18. The panel according to claim 17, wherein the first directional fibers are woven into second directional fibers thereby defining a weave pattern ratio.

19. The panel according to claim 18, wherein the weave pattern ratio includes one of the first directional fibers and the second directional fibers jumping and ducking the other of the first directional fibers and the second directional fibers by an amount of fibers, wherein the amount of fibers includes two fibers, three fibers or four fibers.

20. The panel according to claim 17 further comprising:
an encasing material that impregnates the one or more first reinforcement layers and the one or more second reinforcement layers for adhering:
the core layer to the one or more first reinforcement layers, and
the one or more first reinforcement layers to the one or more second reinforcement layers for forming
an encased panel.

21. The panel according to claim 20, wherein the encasing material includes
a polyurethane material.

22. The panel according to claim 20, wherein the encasing material includes
a polypropylene material.

23. The panel according to claim 17, wherein the randomly chopped fibers of the one or more first reinforcement layers and the first and second directional fibers of the one or more second reinforcement layers are each bound together with
a polyurethane material.

24. The panel according to claim 17, wherein the randomly chopped fibers of the one or more first reinforcement layers and the first and second directional fibers of the one or more second reinforcement layers are each bound together with
a polypropylene material.

25. The panel according to claim 17, wherein the first and second directional fibers of the one or more second reinforcement layers are
linear fibers.

26. The panel according to claim 17, wherein the core layer includes
a honeycomb geometry.

27. The panel according to claim 26, wherein the core layer includes a material that is selected from the group consisting of: polypropylene, paper and polyurethane foam.

28. The panel according to claim 17, wherein the panel does not include metal or metal reinforcements in order to provide stiffness in any direction (X, Y, Z).
